(19) United States
(12) Patent Application Publication
(10) Pub. No.: US 2013/0244683 A1
(43) Pub. Date: Sep. 19, 2013

(54) WIRELESS COMMUNICATION SYSTEM, TRANSMISSION CHANNEL SELECTION METHOD, AND TRANSMISSION CHANNEL SELECTION PROGRAM

(71) Applicants: Hidenobu Fukumasa, Osaka-shi (JP); Shuichi Takehana, Osaka-shi (JP); Shusaku Fukumoto, Osaka-shi (JP); Shiro Sugahara, Osaka-shi (JP)

(72) Inventors: Hidenobu Fukumasa, Osaka-shi (JP); Shuichi Takehana, Osaka-shi (JP); Shusaku Fukumoto, Osaka-shi (JP); Shiro Sugahara, Osaka-shi (JP)

(73) Assignee: SHARP KABUSHIKI KAISHA, Osaka-shi, Osaka (JP)

(21) Appl. No.: 13/988,828

(22) PCT Filed: Nov. 24, 2011
(86) PCT No.: PCT/JP2011/077041

§ 371 Date: May 22, 2013

(30) Foreign Application Priority Data
Nov. 25, 2010 (JP) 2010-262530

(51) Int. Cl. H04W 72/08

(52) U.S. Cl. CPC H04W 72/085
USPC 455/452.2

(57) ABSTRACT

A transmission channel selection method includes: collects information for calculating evaluation values of each of a plurality of transmission channels, and calculates separate evaluation values of the transmission channels individually with respect to each of a plurality of mobile stations; reduces the number of candidates for the transmission channels with respect to the plurality of mobile stations using the separate evaluation values; collects information for jointly calculating evaluation values of the transmission channels with respect to at least one of the plurality of mobile stations, and calculates the joint-separate evaluation values; and selects the communication paths of the plurality of mobile stations using the separate evaluation values and the joint-separate evaluation values.

### TECHNICAL FIELD

The present invention relates to a wireless communication system, a transmission channel selection method, and a transmission channel selection program.

The subject application claims priority based on the patent application No. 2010-262530 filed in Japan on Nov. 25, 2010 and incorporates by reference herein the content thereof.

### BACKGROUND ART

In recent years, wireless communication systems, compared with former communication systems with only telephone applications, are directed to systems extended to new multimedia data communication services, such as internet connection functions, music distribution functions, movie distribution functions, and electronic payment functions. For this reason, higher wireless quality is demanded, and the transmitting power of a mobile station is limited by such factors as battery capacity. It is therefore difficult to expand the wireless area covered by one base station. Given this, the following wireless communication system is used, with the object of expanding the wireless service area and improving communication quality (Patent Reference 1). In this wireless communication system, a relay station is installed at the distant edge of a communication service area or in a zone of poor radio signal coverage, and relay communication between a wireless base station and a mobile station is performed via the relay station.

Patent Reference 2 describes a wireless communication system between a base station and a mobile station via a relay station. In this wireless communication system, when judging whether the base station and the mobile station are to communicate by a transmission channel or via a relay station, evaluation values of each channel are calculated from the information of the frequency band and transmission time to be used, the propagation loss value, the propagation loss value variation width, the relative movement velocity, and the transmitted power value, and the channel is calculated based on the evaluation values.

### PRIOR ART DOCUMENTS

### Patent References

[Patent Reference 1] Japanese Unexamined Patent Application, First Publication No. 2008-60951
[Patent Reference 2] Japanese Unexamined Patent Application, First Publication No. 2010-232945

### SUMMARY OF THE INVENTION

### Problem to Be Solved by the Invention

However, in a mobile communication system, and particularly in a mobile communication system used in a cellular system, a plurality of mobile stations are involved. For this reason, the separate calculation of the evaluation values to which a relay station such as this is related for each mobile station individually does not provide an optimal solution as an overall system. Additionally, the joint-separate calculation of evaluation values for all the mobile stations related to a given base station requires a huge amount of calculation. As a result, in addition to an increase in the amount of time required for calculation, there is wasteful consumption of electrical power.

The present invention provides a wireless communication system, a transmission channel selection method, and a transmission channel selection program capable of optimally selecting a communication channel, with a small amount of calculation, a small power consumption, and a short calculation time.

### Means to Solve the Problem

(1) A first aspect of the present invention is a transmission channel selection method in a wireless communication system having a base station, a plurality of mobile stations, and at least one relay station that relays transmission of data between the base station and the plurality of mobile station, and at least two usable paths of a plurality of transmission channels transmitting data between the base station and the plurality of mobile station, the transmission channel selection method including: collecting information for calculating the evaluation values of each of the plurality of transmission channels, and calculating the separate evaluation values of the transmission channels individually with respect to each of the plurality of mobile stations; reducing the number of candidates for the transmission channels with respect to the plurality of mobile stations using the separate evaluation values; collecting information for jointly calculating evaluation values of the transmission channels with respect to at least one of the plurality of mobile stations, and calculating the joint-separate evaluation values; and selecting the communication paths of the plurality of mobile stations using the separate evaluation values and the joint-separate evaluation values.
(2) In addition, in the first aspect of the present invention, the information for calculating the separate evaluation values may be propagation path losses measured at the plurality of mobile stations, including the propagation loss of the downlink from the base station or the at least one of the relay stations.
(3) In addition, in the first aspect of the present invention, the information for calculating the separate evaluation values may be propagation path losses measured at the base station or the relay station, including the propagation path losses of the uplink from the plurality of the mobile stations.
(4) In addition, in the first aspect of the present invention, the information for calculating the joint-separate evaluation values may include downlink channel state information measured at the plurality of mobile stations.
(5) In addition, in the first aspect of the present invention, the information for calculating the joint-separate evaluation values may include first, third or fifth transmission channel segment uplink channel state information measured at the base station or the relay station.
(6) In addition, in the first aspect of the present invention, in case that the number of candidate of the transmission channel is to be reduced, the difference of the separate evaluation values between the first-ranking evaluation value and the second-ranking evaluation value may be compared with a predetermined value, and in case that the compared result is smaller than the predetermined value, remaining values may be reduced, leaving the paths corresponding to the first-ranking evaluation value and the second-ranking evaluation value.
(7) In addition, in the first aspect of the present invention, in case that the joint-separate evaluation values are calculated, the joint-separate evaluation values of the case of applying MU-MINO with respect to the plurality of mobile station may be calculated, and joint-separate evaluation values in the case of suppressing interference by beam forming may be calculated.
(8) A second aspect of the present invention is a transmission channel selection method in a wireless communication system having a base station, a plurality of mobile stations, and at least one relay station that relays transmission of data between the base station and the plurality of mobile station, and having at least two usable paths of a plurality of transmission channels transmitting data between the base station and the plurality of mobile stations, the transmission channel selection method including: transmitting, by the plurality of mobile stations, quality measurement values of the transmission channel segments between the base station and at least one of the relay stations, and the plurality of mobile station; transmitting, by a controller, to the mobile station a signal that requests communication path state information of at least two segments between the base station and at least one of the relay stations, and the plurality of mobile stations; and transmitting, by the plurality of mobile station, communication path state information of at least two segments between the base station and the relay station, and the plurality of mobile stations.
(9) A third aspect of the present invention is a transmission channel selection method in a wireless communication system having a base station, a plurality of mobile stations, and at least one relay station that relays transmission of data between the base station and the plurality of mobile station, and having at least two usable paths of a plurality of transmission channels transmitting data between the base station and the plurality of mobile stations, the transmission channel selection method including: transmitting, by at least one of the relay stations, to a controller quality measurement values of the transmission channel segments between the plurality of mobile stations; transmitting, by the controller, to at least one of the relay station a signal that requests communication path state information of at least two segments between at least one of the relay stations and the plurality of mobile stations; and transmitting, by at least one of the relay stations, to the controller communication path state information of at least two segments between at least one of the relay stations and the plurality of mobile stations.
(10) A fourth aspect of the present invention is a wireless communication system having a base station, a plurality of mobile stations, and at least one relay station that relays transmission of data between the base station and the plurality of mobile station, and having at least two usable paths of a plurality of transmission channels transmitting data between the base station and the plurality of mobile stations, the base station including: a joint-separate evaluation value calculation unit configured to calculate joint-separate evaluation values of transmission channels; and a transmission channel deciding unit configured to decide a transmission channel based on the joint-separate evaluation values calculated by the joint-separate evaluation value calculation unit.
(11) A fifth aspect of the present invention is a transmission channel selection program causing a computer to execute a program, the program performing: collecting information for calculating evaluation values of each of transmission channels, and calculating separate evaluation values of the transmission channels individually with respect to each of a plurality of mobile stations; reducing the number of candidates for the transmission channels with respect to the plurality of mobile stations using the separate evaluation values; collecting the information for jointly calculating evaluation values of the transmission channels with respect to at least one of the plurality of mobile stations, and calculating joint-separate evaluation values; and selecting the communication paths of the plurality of mobile stations using the separate evaluation values and the joint-separate evaluation value.

### Effect of the Invention

According to the present invention, it is possible to easily select an optimal channel in mobile communication.

### BRIEF DESCRIPTION OF THE DRAWINGS

FIG. 1 is a conceptual drawing of a wireless communication system according to an embodiment of the present invention.

FIG. 2 is a simplified block diagram showing the constitution of a relay station according to the embodiment.

FIG. 3 is a simplified block diagram showing the constitution of a mobile station according to the embodiment.

FIG. 4 is a simplified block diagram showing the constitution of a base station according to the embodiment.

FIG. 5 is a table showing an example of separate evaluation values for each terminal and each channel according to the embodiment.

FIG. 6 is a flowchart showing the operation of a wireless communication system according to the embodiment.

### EMBODIMENT FOR CARRYING OUT THE INVENTION

An embodiment of the present invention will be described in detail below, with references made to the drawings.

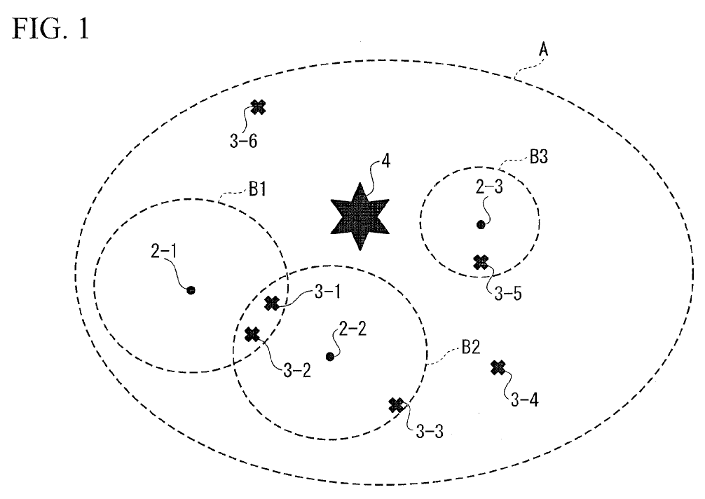

FIG. 1 is a simplified drawing showing a mobile communication system according to the embodiment of the present invention.

In the present embodiment, in the example to be described, the number of base stations is one, the number of relay stations is three, and the number of mobile stations (sometimes referred to as terminals or communication terminals) is six.

In FIG. 1 a base station 4 (where a base station is sometimes referred to as BS) has a communication service area A. The base station 4 establishes transmission channels for wireless communication with the mobile stations 3-1 to 3-6 (a mobile station sometimes referred to as MS) or relay stations 2-1 to 2-3 (a relay station sometimes referred to as RN).

The relay stations 2-1 to 2-3 have communication service areas B1 to 133. The relay stations 2-1 to 2-3 are installed at locations that are at a great distance from the base station 4 or in areas of poor radio signal coverage, and are provided for expansion of the communication service area of the base station 4 and to improve communication quality. The mobile stations 3-1 to 3-6 are portable communication terminals that can be used by a user. A communication service area is sometimes referred to as a cell area or simply an area. The relay stations 2-1 to 2-3 are sometimes collectively referred to as a relay station 2, and the mobile stations 3-1 to 3-6 are sometimes collectively referred to as a mobile station 3.

At this point, the transmission channel (wireless communication channel) between a relay station (RNi) (where i=1 to 3), a mobile station (MS1), and a base station (BS1) will be described. The following four channels exist between the base station 4 (BS) and the mobile station 3-1 (MS1).

### Path 0: BS→MS1

### Path 1: BS→RN1→MS1

### Path 2: BS→RN2→MS1

### Path 3: BS→RN3→MS1

That is, path 0 is the path on which direct communication is done from the base station to the mobile station. Channel 0 includes one transmission channel. The other paths 1, 2, and 3 are paths on which communication is done from the base station, relayed via one of the relay stations, to the mobile station. These paths i (i=1 to 3) include the two transmission channel segments BS-RNi and RNi-MS1.

The communication service areas B1 to B3 shown by broken lines in FIG. 1 show the communication service areas of the relay stations 2-1 to 2-3. The base station 4 includes a controller that controls the selection of a plurality of transmission channel (wireless communication paths) within that area. This controller will be described later. The wireless communication system of the present embodiment may be constituted by a greater number of base stations, relay stations, and mobile stations than described above.

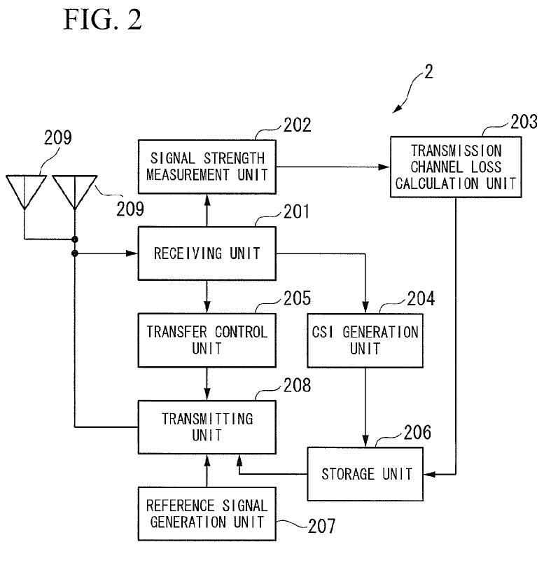

FIG. 2 is a simplified block diagram showing the constitution of a relay station 2 according to the embodiment of the present invention. The constitution of the simplified block diagram shown in FIG. 2 is common to the relay stations 2-1 to 2-3.

The relay station 2 has a receiving unit 201, a signal strength measurement unit 202, a transmission channel loss calculation unit 203, a CSI generation unit 204, a transfer control unit 205, a storage unit 206, a reference signal generation unit 207, a transmitting unit 208, and antennas 209. The relay station 2 additionally has general functions that are known as functions of a relay station.

The receiving unit 201 converts to a received signal a spatially multiplexed wireless signal using a MIMO technique, which is a wireless signal transmitted by the base station 4 or a mobile station 3-1 to 3-6 and received by a plurality of antennas 209. FIG. 2 shows two antennas as an example of a combination transmitting/receiving antenna that receives a spatially multiplexed wireless signal. Additionally, the receiving unit 201 further performs demodulating, decoding, or other processing with respect to the received signal to convert it a baseband signal. The receiving unit 201 outputs the baseband signal to the signal strength measurement unit 202, the CSI control unit 204, and the transfer control unit 205.

The signal strength measurement unit 202 inputs from the receiving unit 201 reference signal that is transmitted from the base station 4 and the mobile station 3. The signal strength measurement unit 202 measures the strength of the input reference signal. The signal strength measurement unit 202 outputs the measured reference signal strength signal I_{RF} to the transmission channel loss calculation unit 203.

The transmission channel loss calculation unit 203, based on the reference signal power I_{RF} output by the signal strength measurement unit 202 and the reference signal power I_{RF0} at the time of transmission that has been transmitted from the transmitting station (in this example, the base station 4 or the mobile station 3), calculates the ratio of the powers between the two (I_{RF}/I_{RF0}). The power ratio I_{RF}/I_{RF0} between the two calculated by the transmission channel loss calculation unit 203 is taken as the transmission loss of each of the transmission channels. If the transmitting station is the base station, the transmission channel loss becomes the downlink transmission channel loss between the base station and this relay station. If the transmitting station is the mobile station, the transmission channel loss becomes the uplink transmission channel loss between the mobile station and this relay station.

If the power of the reference signal transmitted from the base station 4 and the mobile station 3 and used in the calculation is pre-established (for the case of a base station), that value may be recorded into the transmission channel loss calculation unit and then used. If the power of the reference signal transmitted from the base station 4 and the mobile station 3 changes each time, the reference signal power obtained from information regarding the strength of a separately transmitted reference signal may be used.

The CSI generation section 204 inputs from the receiving unit 201 a signal output by the base station 4 that requests the CSI. In this case the CSI (channel state information) is information that represents the channel state in MIMO (multi-input, multi-output). The CSI is an N_{MS}×N_{BS} complex number channel matrix, with N_{BS} being the number of antennas of the base station and N_{MS} being the number of antennas of the mobile station. The channel matrix will be described in detail later. The CSI generation unit 204 receives the reference signal transmitted by the transmitting station side and, using the amplitude and phase information of the received signal, generates the CSI of each transmission channel. The CSI will be described in detail later. The CSI generation unit 204 outputs the generated CSI information to the transmitting unit 208.

The transfer control unit 205, based on the communication path information output by the base station 4, judges whether the relay station 2 is to relay communication. If the judgment is that the relay station 2 is to relay communication, the data to be relayed is input from the receiving unit 201, and output to the transmitting unit 208. If the judgment is not made that the relay station 2 is to relay communication, transmission of data is not done from the receiving unit 201 to the transmitting unit 208.

The storage unit 206 holds information such as transmission channel loss calculated by the transmission channel loss calculation unit 203, the CSI information generated by the CSI generation unit 204, and the relay station ID (relay station identifier) assigned to the relay station 2.

The reference signal generation unit 207 generates and outputs to the transmitting unit 212 a reference signal for use in calculating the transmission channel loss, the SIR (signal interference ratio, which is the power ratio of the interference signal to the received signal), and the CSI between the base station 4 and the mobile station 3. The transmitting unit 208 performs frame configuration with respect to a data series to be transmitted from the relay station 2 to the base station 4 and the mobile station 3, determines the resource block allocation, performs encoding processing, and generates a baseband signal. Additionally, the transmitting unit 208 performs processing such as pre-coding (performing matrix operations on the MIMO signal at the transmitting side beforehand), which is necessary for MIMO transmission. The transmitting unit 208 also frequency converts the baseband signal to a wireless signal. The transmitting unit 208 also amplifies the wireless signal and outputs it to the antennas 209.

The antennas 209 transmit the signal output from the transmitting unit 208 as radio signals.

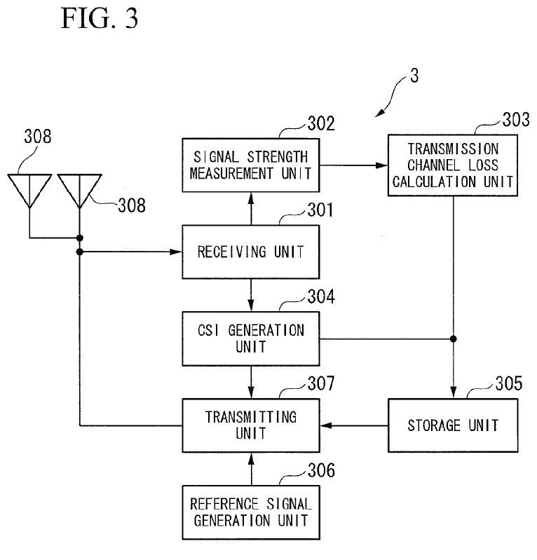

FIG. 3 is a simplified block diagram showing the constitution of a mobile station 3 according to the embodiment of the present invention.

The constitution of the simplified block diagram shown in FIG. 3 is common to the mobile stations 3-1 to 3-6.

The mobile station 3 has a receiving unit 301, a signal strength measurement unit 302, a transmission channel loss calculation unit 303, a CSI generation unit 304, a storage unit 305, a reference signal generation unit 306, a transmitting unit 307, and antennas 308. The mobile station 3 additionally has general functions that are known as functions of a relay station.

Comparing the constituent elements included in the mobile station 3 with the constituent elements included in the relay station 2, the mobile station 3 does not have the transfer control unit 205 of the relay station 2. However, because the functions of each of the receiving unit 301, the signal strength measurement unit 302, the transmission channel loss calculation unit 303, the CSI generation unit 304, the storage unit 305, the reference signal generation unit 306, the transmitting unit 307, and the antennas 308 of the mobile station 3 have the same constitutions as the each of the corresponding parts (the receiving unit 201, the signal strength measurement unit 202, the transmission channel loss calculation unit 203, the CSI generation unit 204, the storage unit 206, the reference signal generation unit 207, the transmitting unit 208, and the antennas 209) of the relay station 2, the description thereof will be omitted. That is, the constitution and functionality of the mobile station 3 differ only from the lack of the constitution and functionality of the transfer control unit 205 of the relay station 2, and are the same constitution and functionality as the relay station 2 with respect to other points.

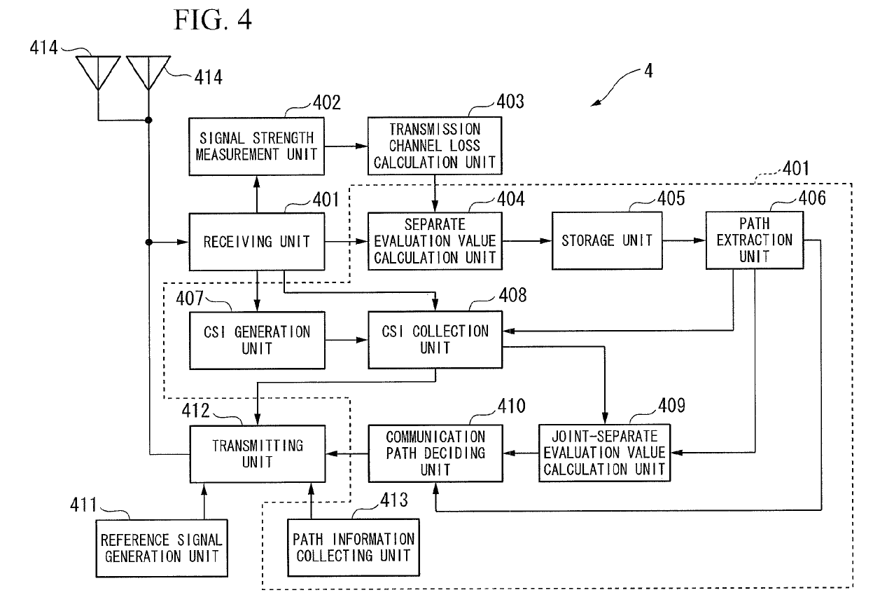

FIG. 4 is a simplified block diagram showing the constitution of a base station 4 of the embodiment of the present invention.

The base station 4 has a receiving unit 401, a signal strength measurement unit 402, a transmission channel loss calculation unit 403, a separate evaluation value calculation unit 404, a storage unit 405, a path extraction unit 406, a CSI generation unit 407, a CSI collection unit 408, a joint-separate evaluation value calculation unit 409, a communication path deciding unit 410, a reference signal generation unit 411, a transmitting unit 412, a path information collecting unit 413, and antennas 414. The base station 4 additionally has general functions that are known as functions of a relay station.

Comparing the constituent elements included in the base station 4 with the constituent elements included in the relay station 2, because the constitution and the functionality of each of the receiving unit 401, the signal strength measurement unit 402, the transmission channel loss calculation unit 403, the CSI generation unit 407, the reference signal generation unit 411, the transmitting unit 412, and the antennas 414 included in the base station 4 are the same as the corresponding parts (the receiving unit 201, the signal strength measurement unit 202, the transmission channel loss calculation unit 203, the CSI generation unit 204, the reference signal generation unit 207, the transmitting unit 208, and the antennas 209) of the relay station 2 shown in FIG. 2, the description thereof will be omitted. The following description will be mainly of the points of difference.

The separate evaluation value calculation unit 404, using the value of the transmission channel loss input from the receiving unit 401 and the transmission channel loss calculation unit 403, calculates the separate evaluation values for each mobile station and each path. The method of calculating the separate evaluation value will be described in detail later. The separate evaluation value calculation unit 404 outputs the separate evaluation values for each mobile station and each path to the storage unit 405.

The storage unit 405 stores the separate evaluation values of each mobile station and each path output from the separate evaluation value calculation unit 404. The storage unit 405, in response to a request from the path extraction unit 406, outputs the evaluation values of each mobile station and each path to the path extraction unit 406.

The path extraction unit 406 reads out the separate evaluation values of each mobile station and each path that have been stored in the storage unit 405 and, based on that information, judges whether or not a joint-separate evaluation is to be performed. The path extraction unit 406 outputs to the CSI collection unit 408 and the joint-separate evaluation value calculation unit 409 information regarding each mobile station for which it has been judged that a joint-separate evaluation is to be performed, regarding each of the paths, each mobile station for which a joint-separate evaluation is to be performed and the paths relative to the joint-separate evaluation. The path extraction unit 406 outputs to the communication path deciding unit 410 information regarding the mobile stations for which it has been judged that an overall evaluation is not to be performed and the paths to those mobile stations. The method of judging whether or not a joint-separate evaluation is to be performed will be described in detail later.

The CSI generation unit 407 inputs the reference signals transmitted from the mobile stations 3-1 to 3-6 and the relay stations 2-1 to 2-3. The CSI generation unit 407, based on the phase and amplitude information of the received reference signals, calculates the above-described channel matrix for each transmission channel. The CSI generation unit 407 outputs the calculated channel matrix to the CSI collection unit.

The CSI collection unit 408 inputs from the path extraction unit 406 information regarding the mobile stations and paths selected as the object of joint-separate evaluation. The CSI collection unit 408 selects the CSI of each transmission channel included in the paths to be the object of joint-separate evaluation. The CSI collection unit 408 transmits to the relay stations 2-1 to 2-3 and the mobile stations 3-1 to 3-6 via the transmitting unit 412, so as to transmit the CSI of each selected transmission channel toward the base station 4. The CSI collection unit 408 inputs, via the receiving unit 401, the CSI of each transmission channel transmitted from the relay stations 2-1 to 2-3 and the mobile stations 3-1 to 3-6. The CSI collection unit 408 outputs the collected CSI of each transmission channel to the joint-separate evaluation value calculation unit 409.

The joint-separate evaluation value calculation unit 409, based on information regarding the combination of paths output by the path extraction unit 406 and on CSI information output by the CIS information collection unit 408, calculates the joint-separate evaluation values. The method of calculating the joint-separate evaluation values will be described in detail later. The joint-separate evaluation value calculation unit 409 outputs the calculated joint-separate evaluation values to the communication path deciding unit 410.

The communication path deciding unit 410, based on the joint-separate evaluation values output by the joint-separate evaluation value calculation unit 409 and the separate evaluation values of the paths that were not to be the object of joint-separate evaluation output by the path extraction unit 406, decides the path having the highest communication quality (the smallest joint-separate evaluation value) among the paths from the base station 4 to the mobile stations 3-1 to 3-6. The communication path deciding unit 410 outputs information regarding the path decided as having the highest communication quality to the relay stations 2-1 to 2-3 and the mobile stations 3-1 to 3-6, via the transmitting unit 412.

Next, the method of separate evaluation according to the present embodiment will be specifically described by the example of a path between the base station 4 (BS) and the mobile station 3-1 (MS1).

### (1) Calculation of the Separate Evaluation Value

First, focusing on the mobile station 3-1 (MS1) consider the following paths between the base station 4 (BS1) and the mobile station MS1.

### Path 0: BS1→MS1

### Path 1: BS1→RN1→MS1

### Path 2: BS1→RN2→MS1

### Path 3: BS1→RN3→MS1

Path 0 is the path going from BS1 and directly reaching MS1, without going through RN1 to RN3.

That is, path 0 represents one transmission channel. Paths 1 to 3 are each paths that reach MS1 from BS1 via RN1 to RN3, respectively.

In path 0, only one transmission channel segment (which is sometimes referred to simply as a segment) is used in communication between the base station 4 and the mobile station 3. In contrast to this, in paths 1 to 3, two transmission channel segments are used in communication between the base station and the mobile station, these being between the base station and the relay station and between the relay station and the mobile station. The separate evaluation value calculation unit 404 performs a separate evaluation regarding each of the mobile stations. That is, in the present embodiment, a separate evaluation is performed with respect to the six base stations 3-1 to 3-6 (MS1 to MS6).

The separate evaluation is performed by comparing the relative size of the evaluation values of each of the paths. The evaluation of the evaluation value of each segment in the paths is performed using the transmission channel losses of each segment. In this case, the transmission channel loss is represented by the ratio of the received power of the reference signal received at a mobile station 3, with respect to the transmitted power of the reference signal transmitted from the base station 4 or the relay station 2, this being expressed as a value in decibels (dB). Alternatively, the transmission channel loss is represented by the ratio of the received power of the reference signal received at the relay station 2, with respect to the transmitted power of the reference signal transmitted from the base station 4, this being expressed as a value in decibels (dB).

If a path has only one segment (path 0), the evaluation value of that segment is the evaluation value of the path. If the path has a plurality of segments (paths 1 to 3), the sum of the evaluation values of each segment is the evaluation value of the path.

### (2) Judging Whether or not to Perform Joint-Separate Evaluation

In joint-separate evaluation, evaluation is performed simultaneously with regard to a plurality of different combinations of paths, for two or more mobile stations selected from the plurality of mobile stations 3-1 to 3-6 (MS1 to MS6), thereby calculating the joint-separate evaluation values. In this case, as an example, consider that there are the two mobile stations MS1 and MS2 and three relay stations RN1 to RN3.

The combinations of the mobile station (MS1) paths and the mobile station (MS2) paths are the following 16 paths.

$$E ( MS 1 \text{:} path 0 , MS 2 \text{:} path 0 )$$

$$E ( MS 1 \text{:} path 0 , MS 2 \text{:} path 1 )$$

$$…$$

$$E ( MS 1 \text{:} path 0 , MS 2 \text{:} path 3 )$$

$$E ( MS 1 \text{:} path 1 , MS 2 \text{:} path 0 )$$

$$…$$

$$E ( MS 1 \text{:} path 3 , MS 2 \text{:} path 3 )$$

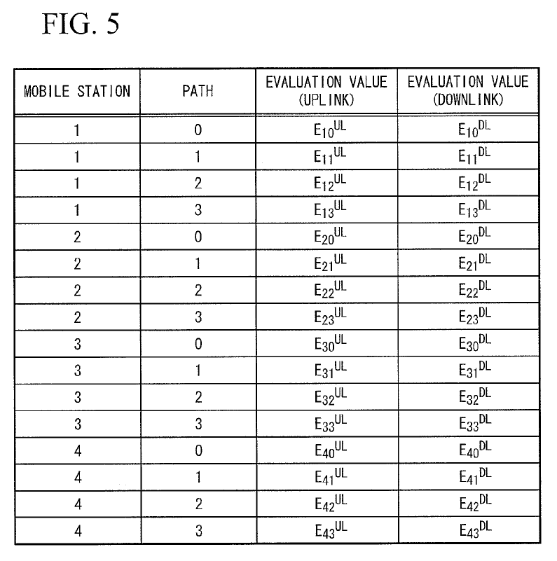

FIG. 5 shows a table of the combinations of the above-noted mobile stations, paths, and evaluation values. In FIG. 5, the example shown is one of three relay stations and four mobile stations with respect to one base station.

The first column of FIG. 5 shows the numbers for distinguishing the mobile stations. The second column of FIG. 5 shows numbers for distinguishing the paths from the base station to the mobile station. The third column of FIG. 5 shows the evaluation values of separate evaluations in the uplink from each mobile station to the base station. The fourth column of FIG. 5 shows evaluation values of the separate evaluations of the downlink from the base station to each mobile station. The information shown in FIG. 5 is calculated in the separate evaluation value calculation unit 404 and stored in the storage unit 405.

If all combinations of these paths are considered, the calculation cost is extremely high compared with separate evaluations. For example, even in a simple model having four paths from the base station to a mobile station, one base station, three relay stations, and six mobile stations, the number of combinations is 4⁶=4096.

In joint-separate evaluation, for example, rather than taking all of the 16 paths in the above-noted example, joint-separate evaluation is taken as the object of joint-separate evaluation, selection is made of only part of the totality of paths. For this reason, the combinations of mobile stations to be the object of the joint-separate evaluations are first selected and limited. Specifically, before performing joint-separate evaluation, separate evaluation is performed for each of the mobile stations and, using evaluation values based on separate evaluations, candidates for joint-separate evaluation are selected based on the size thereof. For example, with regard to the mobile station 3-1 (MS1), the evaluation value Eₚₐₜₕᵢ (i=0 to 3) are calculated for each path, and the candidates for joint-separate evaluation are selected based on the size thereof.

As a result of performing the above-described separate evaluation, assume that Eₚₐₜₕ₁<Eₚₐₜₕ₂<Eₚₐₜₕ₀<Eₚₐₜₕ₃. When a threshold T is pre-established and there are four evaluation values Eₚₐₜₕᵢ (i=0 to 3), if the difference between the smallest evaluation value and the next smallest evaluation value is smaller than the threshold T, these are taken as the objects of joint-separate evaluation. That is, if |Eₚₐₜₕ₂−Eₚₐₜₕ₁|<T, path 1 and path 2 are taken as candidates paths to the mobile station MS1, which are taken as the object of joint-separate evaluation. In the same manner, a comparison is performed of evaluation values using separate evaluation with respect to the mobile stations MS2 to MS6 as well. If, as a result, there also exist other mobile stations for which path 1 and path 2 are candidates, evaluation is performed of the evaluation value by simultaneous joint-separate evaluation including those terminals.

If, for example, as a result of separate evaluation, both mobile station MS1 and mobile station MS2 evaluate path 1 and path 2 as candidates, the following four sets of paths are taken as the objects of joint-separate evaluation.

E (MS1: path 1, MS2: path 1)
E (MS1: path 1, MS2: path 2)
E (MS1; path 2, MS2: path 1)
E (MS1: path 2, MS2: path 2)

### (3) Calculation of the Joint-Separation Evaluation Value

At this point, the method of calculating the joint-separate evaluation value will be specifically described, taking the example of the case in which |Eₚₐₜₕ₂−Eₚₐₜₕ₁|≦T with regard to both the mobile station MS1 and the mobile station MS2.

The evaluation of the joint-separate evaluation value is performed using the channel state information (CSI). The CSI is given in the form of a channel matrix between the base station 4 and a mobile station 3. Taking the number of transmitting antennas of the base station as N_{BS} and the number of receiving antennas of the mobile station as N_{MS}, the CSI is an N_{MS}×N_{BS} (N_{MS}-row, N_{BS}-column) complex number matrix.

Therefore, in contrast with separate evaluation value, in which the evaluation value is the transmission loss, the amount of information in the joint-separate evaluation is greater. However, evaluation using CSI is required in order to implement multi-user MIMO (MU-MIMO, a MIMO technique in which spatial multiplexing is used between a plurality of users) and high-quality communication using beam forming (transmitting diversity by beam forming).

As one example, the method of calculation of the evaluation value when the evaluation value is calculated using joint-separate evaluation of path 1 and path 2 regarding the mobile station MS1 and the mobile station MS2 will be described. For the sake of simplicity, the number of antennas (transmitting antennas) of the relay station 2-1 (RN1) is taken to be two, and the number of antennas (forward antennas) of the mobile stations 3-1 and 3-2 (MS1 and MS2) are both taken to be two. The channel matrix from RN1 to MS1 is taken to be H_{RN1→MS1}, the channel matrix from RN1 to MS2 is taken to be H_{RN1→MS2}, the channel matrix from RN2 to MS1 is taken to be H_{RN2→MS1}, and the channel matrix from RN2 to MS2 is taken to be H_{RN2→MS2}.

Each of the channel matrices is a 2×2 (2-row, 2-column) matrix.

### (A) the Case of Passing Through a Common Relay Station (RN)

First, the method of calculating the joint-separate evaluation value of E (path 1: MS1, path 1: MS2), that is, the case in which both mobile station 3-1 (MS1) and mobile station 3-2 (MS2) take a downlink path that passes through the common relay station 2 (RN) will be described.

If a common relay station (RN) is passed through in this manner, MU-MIMO can be applied with respect to the mobile station MS1 and the mobile station MS2. When MU-MIMO is applied, in addition to signals for the local station, signals (interference components) for the other mobile stations are combined and received.

In this case, equations will be used as an example to describe the signal and the interference components for the case of transmitting from the relay station RN1 to the mobile station MS1 and the mobile station MS2.

First, the elements of the channel matrices are defined. In this example, because N_{MS}×N_{BS}=2×2, the channel matrices are a 2×2 matrices, the matrix elements of which are shown as in the following Equation (1) and Equation (2). In this case H_{RN1→MS1} will be called H⁽¹⁾ and H_{RN1→MS2} will be called H⁽²⁾.

$$\begin{matrix}{H}^{( 1 )} = ( \begin{matrix}{h}_{11}^{( 1 )} & {h}_{12}^{( 1 )} \\ {h}_{21}^{( 1 )} & {h}_{22}^{( 1 )}\end{matrix} ) & ( 1 ) \\ {H}^{( 2 )} = ( \begin{matrix}{h}_{11}^{( 2 )} & {h}_{12}^{( 2 )} \\ {h}_{21}^{( 2 )} & {h}_{22}^{( 2 )}\end{matrix} ) & ( 2 )\end{matrix}$$

In this case, hᵢⱼ⁽¹⁾ is the propagation coefficient from the transmitting antenna j of the relay station RN1 to the receiving antenna i of the mobile station MS1, and hᵢⱼ⁽²⁾ is the propagation coefficient from the transmitting antenna j of the relay station RN1 to the receiving antenna i of the mobile station MS2.

The pre-coding matrix in MIMO transmission is taken to be the 2×2 matrix C. The matrix elements of the matrix C are as shown in Equation (3).

$$C = ( \begin{matrix}{c}_{11} & {c}_{12} \\ {c}_{21} & {c}_{22}\end{matrix} ) \qquad ( 3 )$$

The two sets of transmitted signals are transmitted as separate streams from the two transmitting antennas of the relay station 2-1 (RN1). Therefore, because there are two transmitted signal streams, the transmitted signal Sₑ is a 2×1 vector. The transmitted signal Sₑ is expressed as shown in Equation (4). In this case, Sₑ, and Sₑ₂ indicate the individual streams of the two streams.

$${S}_{e} = ( \begin{matrix}{s}_{e 1} \\ {s}_{e 2}\end{matrix} ) \qquad ( 4 )$$

The mobile station MS1 and the mobile station MS2 each have two receiving antennas. For this reason, each of the received signals received by the mobile station MS1 and the mobile station MS2 are 2×1 vectors. The received signal vector SP of the mobile station MS1 and the received signal vector Sᵣ⁽²⁾ of the mobile station MS2 are expressed as shown in Equation (5) and Equation (6).

$$\begin{matrix}{s}_{r}^{( 1 )} = ( \begin{matrix}{s}_{r 1}^{( 1 )} \\ {s}_{r 2}^{( 1 )}\end{matrix} ) & ( 5 ) \\ {s}_{r}^{( 2 )} = ( \begin{matrix}{s}_{r 1}^{( 2 )} \\ {s}_{r 2}^{( 2 )}\end{matrix} ) & ( 6 )\end{matrix}$$

The received signal Sᵣ⁽¹⁾ of the mobile station 3-1 (MS1) transmitted from the relay station RN is expressed by Equation (7).

Sᵣ⁽¹⁾=H⁽¹⁾CSₑ (7)

If Equation (7) is expanded, we obtain Equation (8). Sᵣ₁⁽¹⁾ and Sᵣ₂⁽¹⁾ indicate the received signals at the antenna 1 and antenna 2, respectively, of the mobile station MS1.

$$( \begin{matrix}{s}_{r 1}^{( 1 )} \\ {s}_{r 2}^{( 1 )}\end{matrix} ) = ( \begin{matrix}{h}_{11}^{( 1 )} & {h}_{12}^{( 1 )} \\ {h}_{21}^{( 1 )} & {h}_{22}^{( 1 )}\end{matrix} ) ( \begin{matrix}{c}_{11} & {c}_{12} \\ {c}_{21} & {c}_{22}\end{matrix} ) ( \begin{matrix}{s}_{e 1} \\ {s}_{e 2}\end{matrix} ) \qquad ( 8 )$$

Additionally, if each component of the received signal Sₑ received by the mobile station MS1 is determined by expansion, it is possible to represent this as Equation (9) and Equation (10).

sᵣ₁⁽¹⁾=(h₁₁⁽¹⁾c₁₁+h₁₂⁽¹⁾c₂₁)sₑ₁+(h₁₁⁽¹⁾c₁₂+h₁₂⁽¹⁾c₂₂)sₑ₂ (9)

sᵣ₂⁽¹⁾=(h₂₁⁽¹⁾c₁₁+h₂₂⁽¹⁾c₂₁)sₑ₁+(h₂₁⁽¹⁾c₁₂+h₂₂⁽¹⁾c₂₂)sₑ₂ (10)

In this manner, in addition to the signal directed toward the mobile station MS1, a signal directed toward the mobile station MS2 is included as an interference signal. That is, in Equation (9) and Equation (10), the first term that includes Sₑ₁ is the desired signal, and the second term that includes Sₑ₂ is the interference signal.

In the same manner, the received signals of the mobile station MS2 are as shown in Equation (11) to Equation (13). The received signal of the mobile station MS2, in addition to the signal directed toward the mobile station MS2, includes the signal directed toward the mobile station MS1 as an interference signal. That is, in Equation (12) and Equation (13), the first term that includes Sₑ₁ is the interference signal, and the second term that includes Sₑ₂ is the desired signal.

$$( \begin{matrix}{s}_{r 1}^{( 2 )} \\ {s}_{r 2}^{( 2 )}\end{matrix} ) = ( \begin{matrix}{h}_{11}^{( 2 )} & {h}_{12}^{( 2 )} \\ {h}_{21}^{( 2 )} & {h}_{22}^{( 2 )}\end{matrix} ) ( \begin{matrix}{c}_{11} & {c}_{12} \\ {c}_{21} & {c}_{22}\end{matrix} ) ( \begin{matrix}{s}_{e 1} \\ {s}_{e 2}\end{matrix} ) \qquad ( 11 )$$

sᵣ₁⁽²⁾=(h₁₁⁽²⁾c₁₁+h₁₂⁽²⁾c₂₁)sₑ₁+(h₁₁⁽²⁾c₁₂+h₁₂⁽²⁾c₂₂)sₑ₂ (12)

sᵣ₂⁽²⁾=(h₂₁⁽²⁾c₁₁+h₂₂⁽²⁾c₂₁)sₑ₁+(h₂₁⁽²⁾c₁₂+h₂₂⁽²⁾c₂₂)sₑ₂ (13)

The SIR of the first antenna and the second antenna of the mobile station MS1 are given by Equation (14) and Equation (15).

$$\begin{matrix}{SIR}_{1}^{( 1 )} = \frac{{\vert {h}_{11}^{( 1 )} {c}_{11} + {h}_{12}^{( 1 )} {c}_{21} \vert}^{2}}{{\vert {h}_{11}^{( 1 )} {c}_{12} + {h}_{12}^{( 1 )} {c}_{22} \vert}^{2}} & ( 14 ) \\ {SIR}_{2}^{( 1 )} = \frac{{\vert {h}_{21}^{( 1 )} {c}_{11} + {h}_{22}^{( 1 )} {c}_{21} \vert}^{2}}{{\vert {h}_{21}^{( 1 )} {c}_{12} + {h}_{22}^{( 1 )} {c}_{22} \vert}^{2}} & ( 15 )\end{matrix}$$

In joint-separate evaluation, the reciprocal of the SIR is taken as the evaluation value of the segment.

In the mobile station MS1, Equation (16) is synthesized by weighting.

$${w}_{1} {s}_{r 1}^{( 1 )} + {w}_{2} {s}_{r 2}^{( 1 )} = [ {w}_{1} ( {h}_{11}^{( 1 )} {c}_{11} + {h}_{12}^{( 1 )} {c}_{21} ) + {w}_{2} ( {h}_{21}^{( 1 )} {c}_{11} + {h}_{22}^{( 1 )} {c}_{21} ) ] {s}_{e 1} + [ {w}_{1} ( {h}_{11}^{( 1 )} {c}_{12} + {h}_{12}^{( 1 )} {c}_{22} ) + {w}_{2} ( {h}_{21}^{( 1 )} {c}_{12} + {h}_{22}^{( 1 )} {c}_{22} ) ] {s}_{e 2} \qquad ( 16 )$$

When maximum ratio combining is performed, the SIR (power ratio of the interference signal to the received signal) is the sum of the SIR of each antenna.

That is, the segment evaluation value is as given in Equation (17).

$$\frac{1}{{SIR}_{1}^{( 1 )} + {SIR}_{2}^{( 1 )}} \qquad ( 17 )$$

Although in the present embodiment, the reciprocal of the sum of the SIR of each antenna has been taken as the segment evaluation value, this may be changed, depending upon the process for receiving processing. For example, when selective diversity is used, the evaluation value may be determined as shown in Equation (18).

$$\frac{1}{max ( {SIR}_{1}^{( 1 )} , {SIR}_{2}^{( 1 )} )} \qquad ( 18 )$$

### (B) the Case of Passing Through Different Relay Stations (RN)

The method of calculating the evaluation value of E (path 1: MS1, path 2: MS2), that is, the case in which the relay station 2-1 (RN1) transmits to the mobile station 3-1 (MS1) and the relay station 2-2 (RN2) transmits to the mobile station 3-2 (MS2) will be described. Because it is known from separate evaluation that the mobile station MS1 and the mobile station MS2 are in substantially the same conditions, if allocation is made to the same resource block, it can be expected that considerable interference will occur, making two-stream MIMO transmission difficult. Given this, in this case one-stream beam forming is done so as to suppress interference, at which time pre-coding is done.

First, consider the case in which transmission is done from the relay station RN1 to the mobile station MS1, using one-stream beam forming, and then transmission is done from the relay station RN2 to the mobile station MS2, using one-steam beam forming. The performance of one-stream transmission is equivalent to setting Sₑ₂ in Equation (3) to 0. Therefore, the signal that reaches the mobile station MS1 by the path RN→MS1 is expressed by Equation (19). In this case, H_{RN1→MS1} is abbreviated H⁽¹⁾.

$${H}^{( 1 )} ( \begin{matrix}{c}_{11} {s}_{e 1}^{( 1 )} \\ {c}_{21} {s}_{e 1}^{( 1 )}\end{matrix} ) = ( \begin{matrix}{h}_{11}^{( 3 )} & {h}_{12}^{( 3 )} \\ {h}_{21}^{( 3 )} & {h}_{22}^{( 3 )}\end{matrix} ) ( \begin{matrix}{c}_{11} {s}_{e 1}^{( 1 )} \\ {c}_{21} {s}_{e 1}^{( 1 )}\end{matrix} ) \qquad ( 19 )$$

When this is done, one-stream beam forming is simultaneously performed from the relay station RN2 to the mobile station MS2 by the same resource block. As a result, a part of the signal transmitted from the relay station RN2 toward the mobile station MS2 is received also by the relay station RN1. The signal that reaches the mobile station MS1 by the path from the relay station RN2 is expressed as shown in Equation (20). In this case H_{RN2→MS1} is abbreviated H⁽³⁾, the elements of which are expressed as hᵢⱼ⁽³⁾. In this case, hᵢⱼ⁽³⁾ is propagation coefficient from transmitting antenna j of the relay station RN2 to the receiving antenna i of the mobile station MS1. The precoding of the relay station RN2 is abbreviated C⁽³⁾, the matrix elements of which are expressed as cᵢⱼ⁽³⁾. In this case, cᵢⱼ⁽³⁾ is an element of the precoding matrix.

$${H}^{( 3 )} ( \begin{matrix}{c}_{11}^{( 3 )} {s}_{e 1}^{( 3 )} \\ {c}_{21}^{( 3 )} {s}_{e 1}^{( 3 )}\end{matrix} ) = ( \begin{matrix}{h}_{11}^{( 3 )} & {h}_{12}^{( 3 )} \\ {h}_{21}^{( 3 )} & {h}_{22}^{( 3 )}\end{matrix} ) ( \begin{matrix}{c}_{11}^{( 3 )} {s}_{e 1}^{( 3 )} \\ {c}_{21}^{( 3 )} {s}_{e 1}^{( 3 )}\end{matrix} ) \qquad ( 20 )$$

If the signal actually received by the mobile station MS1 is expressed as Sᵣ⁽³⁾, this is expressed, as shown in Equation (21), as the sum of signals of Equation (19) and Equation (20). Sᵣ₁⁽³⁾ and Sᵣ₂⁽³⁾ indicate the received signal at the antenna 1 and antenna 2, respectively, of the mobile station MS1.

$$\begin{matrix}{S}_{r}^{( 3 )} = ( \begin{matrix}{s}_{r 1}^{( 3 )} \\ {s}_{r 2}^{( 3 )}\end{matrix} ) \\ = ( \begin{matrix}{h}_{11}^{( 1 )} & {h}_{12}^{( 1 )} \\ {h}_{21}^{( 1 )} & {h}_{22}^{( 1 )}\end{matrix} ) ( \begin{matrix}{c}_{11} {s}_{e 1}^{( 1 )} \\ {c}_{21} {s}_{e 1}^{( 1 )}\end{matrix} ) + ( \begin{matrix}{h}_{11}^{( 3 )} & {h}_{12}^{( 3 )} \\ {h}_{21}^{( 3 )} & {h}_{22}^{( 3 )}\end{matrix} ) ( \begin{matrix}{c}_{11}^{( 3 )} {s}_{e 1}^{( 3 )} \\ {c}_{21}^{( 3 )} {s}_{e 1}^{( 3 )}\end{matrix} )\end{matrix} \qquad ( 21 )$$

Equation (19) is the desired signal component, and Equation (20) is the interference component.

When these are expanded, Equation (22) and Equation (23) are obtained for each antenna component.

sᵣ₁⁽³⁾=(h₁₁⁽¹⁾c₁₁+h₁₂⁽¹⁾c₂₁)sₑ₁⁽¹⁾+(h₁₁⁽³⁾c₁₁⁽³⁾+h₁₂⁽³⁾c₂₁⁽³⁾)sₑ₁⁽³⁾ (22)

sᵣ₂⁽³⁾=(h₂₁⁽¹⁾c₁₁+h₂₂⁽¹⁾c₂₁)sₑ₁⁽¹⁾+(h₂₁⁽³⁾c₁₁⁽³⁾+h₂₂⁽³⁾c₂₁⁽³⁾)sₑ₁⁽³⁾ (23)

The SIR of the first and second antennas of the mobile station MS1 are given by Equation (24) and Equation (25).

$$\begin{matrix}{SIR}_{1}^{( 3 )} = \frac{{\vert {h}_{11}^{( 1 )} {c}_{11} + {h}_{12}^{( 1 )} {c}_{21} \vert}^{2}}{{\vert {h}_{11}^{( 3 )} {c}_{11}^{( 3 )} + {h}_{12}^{( 2 )} {c}_{21}^{( 3 )} \vert}^{2}} & ( 24 ) \\ {SIR}_{2}^{( 3 )} = \frac{{\vert {h}_{21}^{( 1 )} {c}_{11} + {h}_{22}^{( 1 )} {c}_{21} \vert}^{2}}{{\vert {h}_{21}^{( 3 )} {c}_{11}^{( 3 )} + {h}_{22}^{( 2 )} {c}_{21}^{( 3 )} \vert}^{2}} & ( 25 )\end{matrix}$$

In the mobile station MS1 weighting synthesis is done such as shown in Equation (26).

$${w}_{1} {s}_{r 1}^{( 3 )} + {w}_{2} {s}_{r 2}^{( 1 )} = [ {w}_{1} ( {h}_{11}^{( 1 )} {c}_{11} + {h}_{12}^{( 1 )} {c}_{21} ) + {w}_{2} ( {h}_{21}^{( 1 )} {c}_{11} + {h}_{22}^{( 1 )} {c}_{21} ) ] {s}_{e 1} + [ {w}_{1} ( {h}_{11}^{( 3 )} {c}_{11}^{( 3 )} + {h}_{12}^{( 3 )} {c}_{21}^{( 3 )} ) + {w}_{2} ( {h}_{21}^{( 3 )} {c}_{11}^{( 3 )} + {h}_{22}^{( 3 )} {c}_{21}^{( 3 )} ) ] {s}_{e 1}^{( 3 )} \qquad ( 26 )$$

When maximum ratio combining is performed, the SIR (power ratio of the interference signal to the received signal) is sum of the SIR of each antenna. In this case, as shown in Equation (27), the reciprocal of the SIR is taken as the segment evaluation value.

$$\frac{1}{{SIR}_{1}^{( 3 )} + {SIR}_{2}^{( 3 )}} \qquad ( 27 )$$

Although in the present embodiment, the reciprocal of the sum of the SIR of each antenna is taken as the segment evaluation value, this may be changed, depending upon the process for receiving processing. For example, when selective diversity is used, the evaluation value may be determined as shown in Equation (28).

$$\frac{1}{max ( {SIR}_{1}^{( 3 )} , {SIR}_{2}^{( 3 )} )} \qquad ( 28 )$$

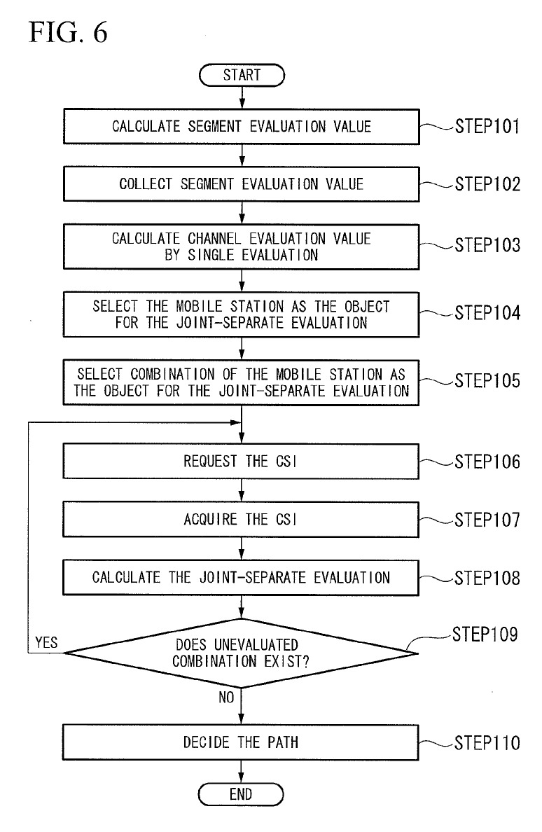

The embodiment of the present invention will be described below, with references made to a flowchart. FIG. 6 is a flowchart showing an example of the processing for joint-separate evaluation in transmission channel selection in the embodiment of the present invention. In this case, as shown in FIG. 1, the description is for the case of one base station 4, three relay stations 2, and six mobile stations.

### (Step 101)

The base station 4 (BS) transmits a reference signal generated by the reference signal generation unit 411 to the mobile stations 3-1 to 3-6, via the transmitting unit 412. In this case, although the method of calculating the segment evaluation value from the base station 4 to the mobile station 3-1 is shown as an example, the method of calculating the segment evaluation values between the base station and the mobile stations 3-2 to 3-6 is the same.

The strength of the reference signal transmitted by the base station 4 is taken as I_{BS}. The mobile station 3-1 to the mobile station 3-6 receive the reference signal transmitted by the base station 4 at the receiving unit 301. The receiving unit 301 outputs the received reference signal to the signal strength measurement unit 302. The signal strength measurement unit 302 determines the strength I_{MS} of the reference signal, based on the reference signal input from the receiving unit 301, and outputs the result to the transmission channel loss calculation unit 303.

The transmission channel loss measurement unit 303 calculates the ratio I_{MS}/I_{BS} between the I_{MS} output by the signal strength measurement unit 302 and the strength I_{BS} of the reference signal transmitted by the base station 4. This value is called the transmission channel loss (segment evaluation value) E of the downlink between the base station and the mobile station.

In this case, I_{BS} that is used in the calculation may be transmitted from the base station 4 via any path and received by the mobile stations 3-1 to 3-6. Also, if the strength I_{BS} of the reference signal transmitted by the base station 4 is established beforehand, the pre-established value may be used, taking it as I_{BS} used in the calculation. The transmission channel loss calculation unit 303 stores the calculated segment evaluation value E in the storage unit 206.

The relay stations 2-1 to 2-3 (RN1 to RN3) transmit the reference signal generated by the reference signal generation unit 207 to the mobile stations 3-1 to 3-6 via the transmitting unit 208. In this case, although the method of calculating the segment evaluation value between the relay station 2-1 and the mobile station 3-1 is shown as an example, the method of calculating the segment evaluation value between another relay station and the mobile stations is the same.

The intensity of the reference signal transmitted by the relay station 2-1 is taken as I_{RN}. The mobile station receives the reference signal transmitted by the base station at the receiving unit 301. The receiving unit 301 outputs the received reference signal to the signal strength measurement unit 302. The signal strength measurement unit 302 determines the strength I_{MS} of the reference signal, based on the reference signal input from the receiving unit 301 and outputs the result to the transmission channel loss calculation unit 303.

The transmission channel loss calculation unit 303 calculates the ratio I_{MS}/I_{RN} between the I_{MS} output by the signal strength measurement unit 302 and the intensity I_{RN} of the reference signal transmitted by the base station. This value is called the transmission channel loss (segment evaluation value) E of the downlink between the relay station 2-1 and the mobile station 3-1. In this case, I_{RN} that is used in the calculation may be a value transmitted from the base station via any path and used the value received at the mobile station. Also, if the strength I_{RN} of the reference signal transmitted by the relay station is known beforehand, a pre-established value may be used, taking it as I_{RN} used in the calculation.

The base station 4 (BS) transmits the reference signal generated by the reference signal generation unit 411 to the relay stations 2-1 to 2-3, via the transmitting unit 412.

In this case, although the example shown is that of the method of calculating the segment evaluation value from the base station 4 to the relay station 2-1, the method of calculating the segment evaluation value between the base station and a relay station is the same. In this case, the strength of the reference signal transmitted by the base station is taken to be I_{BS}. The relay station receives the reference signal transmitted by the base station at the receiving unit 201. The receiving unit 201 outputs the received reference signal to the signal strength measurement unit 202. The signal strength measurement unit 202 determines the strength I_{RN} of the reference signal input from the receiving unit 201 and outputs the result to the transmission channel loss calculation unit 203.

The transmission channel loss calculation unit 203 calculates the ratio I_{RN}/I_{BS} between the I_{RN} output by the signal strength measurement unit 202 and the strength I_{BS} of the reference signal transmitted by the base station. This value is called downlink evaluation value E between the relay station and the mobile station. In this case, I_{BS} may be used as the value transmitted from the base station and received by the relay station. If the strength I_{BS} of the reference signal transmitted by the base station is known beforehand, a pre-established value may be used as I_{BS}.

Although, up until this point, the description has been of the method of calculating the downlink transmission channel loss (segment evaluation value) E, the calculation uses the same method with regard to the transmission channel loss in the uplinks of each transmission channel. Also, in the calculation of the above-described downlink and uplink evaluation values, if the evaluation value cannot be calculated because of, for example, not being able to receive the reference signal, the evaluation value is made a large value, for example, infinity.

### (Step 102)

The path information collection unit 414 transmits to the mobile stations 3-1 to 3-6 and the relay stations 2-1 to 2-3 via the transmitting unit 412 a command (segment information transmission request) that causes the transmission of the calculated evaluation values for each segment to the base station 4.

The relay stations 2-1 to 2-3 and the mobile stations 3-1 to 3-6 receive the segment information transmission request from the base station 4 and the relay stations 2-1 to 2-3 and the mobile stations 3-1 to 3-6 transmit to the base station the uplink and downlink evaluation values that have been calculated by the transmission channel loss estimation unit 203 and stored in the storage unit 206 (relay station) or in the storage unit 305 (mobile station) at step S101.

The base station 4 inputs the evaluation values for each segment transmitted from the mobile stations 3-1 to 3-6 and the relay stations 2-1 to 2-3 into the separate evaluation value calculation unit 404, via the receiving unit 201. The transmission channel loss calculation unit 403 outputs to the separate evaluation value calculation unit 404 the uplink evaluation values for each segment from the relay stations 2-1 to 2-3 and the mobile stations 3-1 to 3-6.

### (Step S103)

The separate evaluation value calculation unit 404 calculates the separate evaluation values for each path, using the evaluation values for each segment input at step S103 and Rᵢ^{UL}:Rᵢ^{DL}, which is the proportion of the amount of uplink traffic to the amount of downlink traffic on each transmission channel. The evaluation values (Eₚₐₜₕ₀, Eₚₐₜₕ₁, Eₚₐₜₕ₂, Eₚₐₜₕ₃) for each path regarding each mobile station are calculated. The evaluation values of each path are calculated using the segment evaluation value of each transmission channel included in the path and Rᵢ^{UL}:Rᵢ^{DL}, which is the proportion of the amount of uplink traffic to the amount of downlink traffic on each transmission channel. For example, the ratio of uplink traffic amount to downlink traffic amount for each transmission channel segment is expressed as Rᵢ^{UL}:Rᵢ^{DL}(Rᵢ^{UL}+Rᵢ^{DL}=1).

This being the case, the evaluation values (Eₚₐₜₕ₀, Eₚₐₜₕ₁, Eₚₐₜₕ₂, Eₚₐₜₕ₃) for each path are expressed as Eₚₐₜₕ₀=Rᵢ^{DL} E (BS1→MS1)+Rᵢ^{UL} E (MS1→BS1), Eₚₐₜₕ₁=Rᵢ^{DL} E (BS1→RN1)+Rᵢ^{DL} E (RN1→MS1)+Rᵢ^{UL} E (MS1→RN1)+Rᵢ^{UL} E (RN1→BS1), . . . , Eₚₐₜₕ₃=Rᵢ^{DL} E (BS1→RN3)+Rᵢ^{DL} E (RN3→MS1)+Rᵢ^{UL} E (MS1→RN3)+Rᵢ^{UL} E (RN3→BS1). In this case, for example, E (BS1→RN1) is the downlink segment evaluation value from the base station BS1 to the relay station RN1. Also, E (MS1→RN1) is the uplink segment evaluation value from the mobile station MS1 to the relay station RN1. A pre-established expected ratio between the uplink traffic amount and the downlink traffic amount may be used as the ratio Rᵢ^{UL}:Rᵢ^{DL} between the uplink traffic amount and the downlink traffic amount, and a value that varies as the amount of traffic varies may be used.

The separate evaluation value calculation unit 404 outputs to the recording unit 405 the path evaluation values by separate evaluation with respect to each path and each terminal calculated as noted above.

### (Step S104)

The path extraction unit 406 reads from the storage unit 405 the evaluation values (Eₚₐₜₕ₀, Eₚₐₜₕ₁, Eₚₐₜₕ₂, Eₚₐₜₕ₃) of paths with respect to one mobile station (for example, MS1), which has been calculated at Step S103. Next, the path extraction unit 406 arranges the evaluation values (Eₚₐₜₕ₀, Eₚₐₜₕ₁, Eₚₐₜₕ₂, Eₚₐₜₕ₃) of paths with respect to the mobile station (MS1) in ascending order, taking these to be (E₀, Eₗ, E₂, E₃) in ascending order. The threshold T is pre-established and, with respect to a mobile station (MS) for which |E₀−E₁|>T with respect to the threshold T, a judgment is made that E₀ has an evaluation value that is clearly advantageous in comparison with the other paths, E₀ being selected as the optimal path. The corresponding path is selected.

In contrast, in the case in which, with respect to the threshold T, |E₀−E₁|≦T, this indicates that evaluation values of the path corresponding to E₀ and the path corresponding to E₁ are generally equal. In this case, the path corresponding to E₀ and path corresponding to E₁ with respect to the mobile station MS1 are selected as the objects for joint-separate evaluation.

The evaluation values for each path are calculated in the same manner for the mobile stations other than the mobile station MS1.

### (Step S105)

The path extraction unit 406 selects, from the mobile station selected at step S104 for joint-separate evaluation and the associated path combinations, a combination of mobile stations such that the paths are equal.

Specifically, consider that the result of separate evaluation of a mobile station (which we will call MSa) is that path 1 and path 2 satisfy |Eₚₐₜₕ₁−Eₚₐₜₕ₂|≦T. Under this condition, consider that, simultaneously, when with regard to a mobile station (MSb) also, which is different from mobile station Msa, |Eₚₐₜₕ₁−Eₚₐₜₕ₂|≦T is satisfied, the mobile station MSa and MSb and paths 1 and 2 are taken as the combination for performing joint-separate evaluation. The path extraction unit 406 outputs to the CSI collection unit 408 information regarding the combination of the mobile station and paths which will be the objects of joint-separate evaluation.

### (Step S106)

The CSI collection unit 408, based on information of the path selected at step S105, requests to the mobile stations, the relay stations, and the base station the CSI of each segment that belongs to the paths that have been the object of joint-separate evaluation. The downlink CSI can be determined by receiving at the mobile station the reference signal transmitted from the base station or the relay station. The uplink CSI can be determined by receiving at the base station or the relay station the reference signal transmitted from the mobile station. If the relay station or the mobile station does not transmit a reference signal, the path information collection unit 414 transmits a command to request transmission of the reference signal to the relay station or mobile station and cause generation of CSI information. After that, processing proceeds to step S107.

### (Step S107)

The receiving unit 201 of the relay station 2 and the receiving unit 301 of the mobile station 3 receive from the base station 4 the signal that requests the CSI of each segment belonging to the path, and output this to the CSI generation unit 204 of the relay station and the CSI generation unit 304 of the mobile station. The CSI generation units 204 and 304, based on the reference signal received by the receiving unit 301, generate CSI information. The CSI information generation units 204, 304 transmit CSI information to the base station 4 via the transmitting unit 208 of the relay station 2 and the transmitting unit 307 of the mobile station 3. The CSI collection unit 408 of the base station 4 obtains via the receiving unit 401 the CSI that has been requested of the mobile station, the relay station, and the base station at step S106, and that is in response to the signal making the request for the CST for each segment belonging to the path. After that, processing proceeds to step S108.

### (Step S108)

The joint-separate evaluation value calculation unit 409, using the path information and CSI information output from the path extraction unit 306 and the CSI collection unit 408, performs joint-separate evaluation to calculate the joint-separate evaluation values with respect to each segment. The calculation of the joint-separate evaluation values is performed by a method that is the same as the method described with reference to Equation (1) to Equation (28). That is, when communication to a plurality of mobile stations passes through the same relay station (RN), a calculation is performed of the joint-separate evaluation values with respect to a plurality of paths that include the case of passing through a different relay station (RN).

If a path is made up of one segment, the joint-separate evaluation value with respect to the segment is equal to the joint-separate evaluation value of the path. If a path passes through a plurality of segments, the sum of the joint-separate evaluation values for each segment is the joint-separate evaluation value of the path. After that, processing proceeds to step S109.

### (Step 109)

The joint-separate evaluation value calculation unit 409 has been selected as the object of joint-separate evaluation in the path extraction unit 406, and a judgment is made as to whether or not there are still mobile stations and combinations of associated paths for which joint-separate evaluation has not been performed is made. If the judgment is made that there is a mobile station and combination of associated paths for which joint-separate evaluation has not been made and which has been selected as an object for joint-separate evaluation, processing proceeds to step S106. If the judgment is made that there is no mobile station and combination of associated paths for which joint-separate evaluation has not been made, and which has been selected as an object for joint-separate evaluation, processing proceeds to step S110.

### (Step S110)

The communication path deciding unit 410, with respect to a mobile station selected by the path extraction unit 406 at step S104 that has not been taken as the object of joint-separate evaluation, decides as the path with respect to that mobile station the path having the smallest separate evaluation value. The communication path deciding unit 410, with respect to the mobile station selected at step S104 as the object for joint-separate evaluation, decides as the path with respect to that mobile station the path having the smallest evaluation value of the paths calculated by the joint-separate evaluation calculation unit 409 upon performing joint-separate evaluation at step S108.

In the above-described manner, according to the present embodiment, information for calculating the evaluation values of each of a plurality of transmission channels is collected, the separate evaluation values of the transmission channels are individually calculated with respect to each of a plurality of mobile station, the number of candidates for the transmission channels with respect to the plurality of mobile station is reduced, using the separate evaluation values, information for jointly calculating the evaluation values of the transmission channels with respect to at least one of the plurality of mobile stations is collected, the joint-separate evaluation values are calculated, and the communication paths of the plurality of mobile stations are selected, using the separate evaluation values and the joint-separate evaluation values. By doing this, the number of paths for which joint-separate evaluation is performed is reduced by using the separate evaluation values of each transmission channel, enabling path selection with a smaller amount of calculation, compared with the case in which the number of paths is not reduced. As a result, it is possible to greatly reduce the required power consumption and also shorten the calculation time.

Although the foregoing has been a detailed description of one embodiment of the present invention, making references to drawings, there is no restriction to the above-described specific constitution, and various design changes and the like may be made within the scope of the present invention.

The overall functionality or part thereof of the various parts of time setting apparatus in each of the above-noted embodiments may be implemented by recording a program for the purpose of implementing this functionality in a computer-readable recording medium. The program recorded in the recording medium may then be read into a computer system and executed to implement this functionality. The term “computer system” as used herein includes an operating system and hardware such as peripheral devices.

The term “computer-readable recording medium” refers to a portable medium such as a flexible disk, an opto-magnetic disk, a ROM, or a CD-ROM, and a storage apparatus such as a hard-disk apparatus built into a computer system. Additionally, the term “computer-readable recording medium” may include one that holds a program dynamically for a short period of time, such as the case of transmitting a program via a network such as the Internet or via a communication circuit such as a telephone line, or one such as a volatile memory within the computer system that is to become a server or a client, in which case the program is held for a certain period of time. The above-noted program may be one for implementing a part of the above-described functionality, and may be one for implementing the above-described functionality in combination with a program that has already been recorded within a computer system.

### INDUSTRIAL APPLICABILITY

Application is possible to a wireless communication system, a transmission channel selection method, and a transmission channel selection program or the like that requires easy path selection in wireless communication.

### REFERENCE SYMBOLS

2-1 to 2-3 Relay station
201 Receiving unit
202 Signal strength measurement unit
203 Transmission channel loss estimation unit
204 CSI generation unit
205 Transfer control unit
206 Storage unit
207 Reference signal generation unit
208 Transmitting unit
209 Antenna
3-1 to 3-6 Mobile station
301 Receiving unit
302 Signal strength measurement unit
303 Transmission channel loss estimation unit
304 CSI generation unit
305 Storage unit
306 Reference signal generation unit
307 Transmitting unit
308 Antenna
4 Base station
4-1 Controller
401 Receiving unit
402 Signal strength measurement unit
403 Transmission channel loss estimation unit
404 CSI generation unit
405 Storage unit
406 Path extraction unit
407 CSI generation unit
408 CSI collection unit
409 Joint-separate evaluation value calculation unit
410 Communication path deciding unit
411 Reference signal generation unit
412 Transmitting unit
413 Path information collection unit
414 Antenna
A Service area of base station 4
B1 to B3 Service areas of relay stations 2-1 to 2-3

1. A transmission channel selection method in a wireless communication system having a base station, a plurality of mobile stations, and at least one relay station that relays transmission of data between the base station and the plurality of mobile station, and at least two usable paths of a plurality of transmission channels transmitting data between the base station and the plurality of mobile station, the transmission channel selection method comprising:
collecting information for calculating the evaluation values of each of the plurality of transmission channels, and calculating the separate evaluation values of the transmission channels individually with respect to each of the plurality of mobile stations;
reducing the number of candidates for the transmission channels with respect to the plurality of mobile stations using the separate evaluation values;
collecting information for jointly calculating evaluation values of the transmission channels with respect to at least one of the plurality of mobile stations, and calculating the joint-separate evaluation values; and
selecting the communication paths of the plurality of mobile stations using the separate evaluation values and the joint-separate evaluation values.

2. The transmission channel selection method according to claim 1, wherein the information for calculating the separate evaluation values is propagation path losses measured at the plurality of mobile stations, including the propagation loss of the downlink from the base station or the at least one of the relay stations.

3. The transmission channel selection method according to claim 1, wherein the information for calculating the separate evaluation values is propagation path losses measured at the base station or the relay station, including the propagation path losses of the uplink from the plurality of the mobile stations.

4. The transmission channel selection method according to claim 1, wherein the information for calculating the joint-separate evaluation values includes downlink channel state information measured at the plurality of mobile stations.

5. The transmission channel selection method according to claim 1, wherein the information for calculating the joint-separate evaluation values includes first, third or fifth transmission channel segment uplink channel state information measured at the base station or the relay station.

6. The transmission channel selection method according to claim 1, wherein,
in case that the number of candidate of the transmission channel is to be reduced, the difference of the separate evaluation values between the first-ranking evaluation value and the second-ranking evaluation value are compared with a predetermined value, and
in case that the compared result is smaller than the predetermined value, remaining values are reduced, leaving the paths corresponding to the first-ranking evaluation value and the second-ranking evaluation value.

7. The transmission channel selection method according to claim 1, wherein
in case that the joint-separate evaluation values are calculated, the joint-separate evaluation values of the case of applying MU-MINO with respect to the plurality of mobile station are calculated, and
joint-separate evaluation values in the case of suppressing interference by beam forming are calculated.

8. A transmission channel selection method in a wireless communication system having a base station, a plurality of mobile stations, and at least one relay station that relays transmission of data between the base station and the plurality of mobile station, and having at least two usable paths of a plurality of transmission channels transmitting data between the base station and the plurality of mobile stations, the transmission channel selection method comprising:
transmitting, by the plurality of mobile stations, quality measurement values of the transmission channel segments between the base station and at least one of the relay stations, and the plurality of mobile station;
transmitting, by a controller, to the mobile station a signal that requests communication path state information of at least two segments between the base station and at least one of the relay stations, and the plurality of mobile stations; and
transmitting, by the plurality of mobile station, communication path state information of at least two segments between the base station and the relay station, and the plurality of mobile stations.

9. A transmission channel selection method in a wireless communication system having a base station, a plurality of mobile stations, and at least one relay station that relays transmission of data between the base station and the plurality of mobile station, and having at least two usable paths of a plurality of transmission channels transmitting data between the base station and the plurality of mobile stations, the transmission channel selection method comprising:
transmitting, by at least one of the relay stations, to a controller quality measurement values of the transmission channel segments between the plurality of mobile stations;
transmitting, by the controller, to at least one of the relay station a signal that requests communication path state information of at least two segments between at least one of the relay stations and the plurality of mobile stations; and
transmitting, by at least one of the relay stations, to the controller communication path state information of at least two segments between at least one of the relay stations and the plurality of mobile stations.

10. A wireless communication system having a base station, a plurality of mobile stations, and at least one relay station that relays transmission of data between the base station and the plurality of mobile station, and having at least two usable paths of a plurality of transmission channels transmitting data between the base station and the plurality of mobile stations, the base station comprising:
a joint-separate evaluation value calculation unit configured to calculate joint-separate evaluation values of transmission channels; and
a transmission channel deciding unit configured to decide a transmission channel based on the joint-separate evaluation values calculated by the joint-separate evaluation value calculation unit.

11. A non-transitory computer readable medium containing a program for causing a computer to execute a transmission channel selection, the program executing:
collecting information for calculating evaluation values of each of transmission channels, and calculating separate evaluation values of the transmission channels individually with respect to each of a plurality of mobile stations;
reducing the number of candidates for the transmission channels with respect to the plurality of mobile stations using the separate evaluation values;
collecting the information for jointly calculating evaluation values of the transmission channels with respect to at least one of the plurality of mobile stations, and calculating joint-separate evaluation values; and
selecting the communication paths of the plurality of mobile stations using the separate evaluation values and the joint-separate evaluation value.
